(19) United States
(12) Patent Application Publication
(10) Pub. No.: US 2003/0024543 A1
(43) Pub. Date: Feb. 6, 2003

(54) Stress relieving gel handle tools for the salon and spa

(76) Inventor: Shane D. Wolf, Jersey City, NJ (US)

Correspondence Address: Peter Giancana, Estee Lauder Companies, Inc., 125 Pinelawn Road, Melville, NY, 11747, US

(21) Appl. No.: 09/923,113

(22) Filed: Aug. 6, 2001

(51) Int. Cl. A45D 7/02; B26B 13/00; A45C 7/00

(52) U.S. Cl. 132/212; 30/194; 16/430

(57) ABSTRACT

The invention relates to salon and spa tools comprising a head region and a handle region, the handle region comprising a stem, the stem having a deformable grip that is adapted to receive at least a portion of the stem into itself.

### FIELD OF THE INVENTION

The invention relates to beauty salon and spa tools. More specifically, the invention relates to handheld tools that are ergonomically designed for enhanced ease of use, decreased fatigue and reduced likelihood of repetitive strain injuries.

### BACKGROUND OF THE INVENTION

A typical salon or spa tool, such as a comb, shears, hand-held blow dryer or massage implement, is designed of hard plastic material or wood. The hardness of the material is in many ways a benefit because it withstands the stresses that are required of it during use. Such material, however, is hard and uncomfortable on the hand of the user. This is particularly true for professional salon or spa staff who may use these tools for several hours each day. In the course of a day, this discomfort may lead to fatigue of the hands, wrists and arms resulting in decreased performance of the salon or spa professional.

Furthermore, generally, conventional salon and spa tools do not encourage proper musculo-skeletal alignment of the hands, wrists and forearms. In fact, the discomfort caused by these tools may further encourage poor alignment as the user places an unconventional grip on the tool to avoid the pain. Because the discomfort is thus temporarily relieved, the user may continue to work for a period of time employing an alignment that is detrimental to his/her health. Improper musculo-skeletal alignment combined with the frequent, repetitive use that a professional undertakes is one of the major causes of repetitive strain injuries. In particular, carpal tunnel syndrome has become a major health concern in recent years. Efforts to address the causes of carpal tunnel syndrome have included altering the work environment, taking more frequent breaks, stretching the affected tendino-muscular structures and educating workers about proper posture and body mechanics. In general, in the beauty salon and spa industry, deformable grips that respond to the pressure of the user's hand by changing shape either temporarily or permanently, and that reduce discomfort and fatigue and that enable the user to assume improved musculo-skeletal alignment are unknown.

Grips of this type have been disclosed, for example, in International Publication No. WO 00/47081 and in U.S. Pat. No. 5,000,599, the contents of which are herein incorporated by reference, in their entirety. However, the grips have, to Applicant's knowledge, only been disclosed for use on hair brushes and writing implements, and not for wider use on all manner of salon and spa tools as described herein. In contrast, the present invention now provides a means for reducing the discomfort and fatigue associated with the use of a variety of salon and spa tools, the handles of which are specifically adapted to ease the strain on the hands, wrists and forearms of the user.

### SUMMARY OF THE INVENTION

The present invention relates to salon and spa tools comprising a head containing one or more elements adapted to be directed toward the hair or body, and a handle that is at least partially surrounded by a grip material that is deformable by a user's fingers or hand. In a preferred embodiment, the handle is at least partially surrounded by a gel- or putty-like material that responds to the pressure of the user's hand in such a way as to either temporarily or substantially permanently conform to the grip of the user. The terms salon tools and spa tools refer to any handheld implement that comprises a head containing one or more elements adapted to be directed toward the hair or body. A non-exhaustive list of salon and spa tools that are within the scope of this invention includes: manual hair cutting tools, such as cutting shears, thinning shears, texturizing shears and razors; electric hair cutting tools, such as hair clippers, buzzers, edgers and razors; manual hair styling tools, such as combs, hair clips, decorations and sectioning tools; electric hair styling tools, such as blow dryers, flat irons, crimping irons, curling irons, hot irons and thermal styling tools; nail care tools, such as files, clippers, buffers, nippers and pushers; skin care and make-up tools, such as applicators and pads; massage accessories, such as manual and electric handheld massagers. Also within the scope of the present invention is any other salon or spa tool that comprises a handle such that the handle may be at least partially surrounded by a gel- or putty-like material that responds to the pressure of the user's hand.

### BRIEF DESCRIPTION OF THE FIGURES

FIG. 1 shows a fragmented perspective view illustrating a portion of a tool handle and grip of the invention.

FIG. 2 shows a cross section through line A-A of FIG. 5, in an embodiment with grip composed of a single outer sleeve layer enclosing a viscous material.

FIG. 3 shows a cross section through line A-A of FIG. 15 in an embodiment with a grip composed of a sleeve with an outer layer and inner layer surrounding the viscous material.

FIG. 4 shows a cross section through line A-A of FIG. 5 in an embodiment with a grip composed of a sleeve with an outer layer and inner layer integrally formed with radially interconnecting webs defining chambers surrounding the viscous material, the webs containing vents permitting the passage of the viscous material from one chamber to another.

FIG. 5 shows a side view of a razor of the invention, particularly showing the modified handle of the invention with a cylindrical sleeve grip.

FIG. 6 shows an elevation view of a curling iron of the invention, particularly showing the modified handle of the invention with a cylindrical sleeve grip.

FIG. 7 illustrates a typical comb fitted with a grip of the present invention.

FIG. 8 depicts thinning shears in which the inner diameters of the finger loops have been fitted with a grip of the present invention.

FIG. 9 illustrates a flat iron fitted with a grip of the present invention.

FIG. 10 illustrates a handheld hair dryer fitted with a grip of the present invention.

FIG. 11 illustrates an electric hair clipper fitted with a grip of the present invention.

FIG. 12 illustrates a hair clip fitted with a grip of the present invention.

FIG. 13 is a section view showing an embodiment of the grip that is folded in on itself, creating a groove for receiving at least a portion of the stem of a handle.

### DETAILED DESCRIPTION OF THE INVENTION

A typical salon or spa tool is composed of a body that is divisible visibly into two opposing ends, one end being designated as the head, which contacts or is directed toward the hair or body of the client, and the opposite end being adapted into a handle shape to permit gripping and ease of movement of the tool by the hand of the user. The handle is frequently composed of plastic or wood, but may also be composed of metal, or a combination of metal with one of the other materials. These materials are typically hard on the hand of the user. The tools of the invention possess these typical elements, but also exhibit the further improvement of a modification of the handle which permits the user to utilize the brush over long periods of time without tiring or causing pain to the hands. In particular, a unique feature of such a tool is the presence, over at least a portion of the handle, of a deformable grip that responds to the pressure of the user's hand and changes shape either temporarily or permanently, depending upon the composition of the grip. The grip of the present invention is capable of receiving into itself the stem of the handle of the salon tool. The grip may do this by being in the form of a sleeve that surrounds the stem. Alternatively, the grip may receive the stem into itself by having a portion of the grip that is folded in on itself.

The grip of the invention is formed of a material with a substantial degree of elasticity, having a gel-like feel in the hand. The grip is shaped to receive into itself at least a portion of the handle, the exact shape being dictated by the handle to be covered. The grip can be, for example, a deformable solid rubber or deformable solid plastic that is slipped over the handle of the tool. In a preferred embodiment, however, the grip comprises an outer surface of thin deformable rubber or plastic, surrounding an inner layer of an internal viscous deformable medium, all surrounding at least a portion of the handle of the tool. In another embodiment an inner surface is disposed between the handle and the deformable viscous medium.

Alternatively, the grip may be an extrusion defining an outer resilient surface connecting to inner radially extending webs, that in turn communicate with an inner surface that surrounds at least a portion of the handle. The cooperation of the surfaces with the webs forms a plurality of chambers, which receive and contain a flowable viscous substance, such as a silicone-based lubricant or sealant. The webs contain vents that permit movement between chambers, so that when pressure is applied, the shape of the grip alters by movement of the viscous material, but when pressure is relieved, the viscous material gradually returns to its original location, and the original shape of the grip eventually returns.

Examples of the internal deformable medium include putty-like vinyl elastomers and or silicone-based materials, such as the material referred to as Silly Putty (Dow Chemical). Such materials have a great deal of elasticity, but are slow to return to the original shape, so that the user's particular custom grip is retained for a short period of time, but eventually can be used by others, at which time a new custom grip will be temporarily imprinted.

Alternatively, the deformable substance may be a room temperature curable substance that, after an initial period of adaptation to the user's custom grip, retains that custom conformation. Examples of useful materials for that purpose include room temperature curable silicone-based substances or the like that are initially activated by exposure to heat, air or other appropriate stimuli. In addition, the grip may be a surface forming a bladder, within which is contained the viscous material of choice.

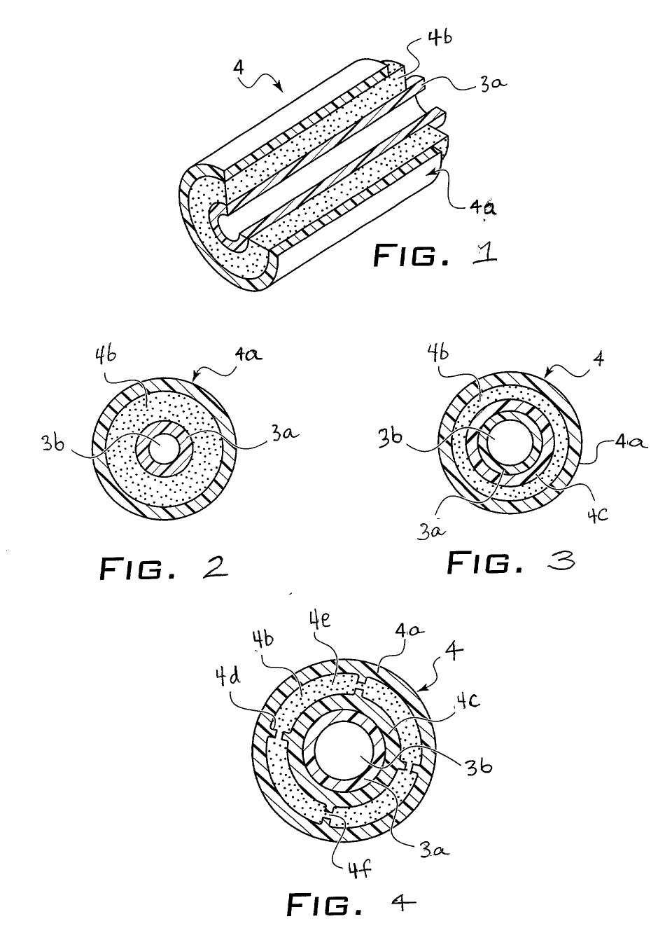

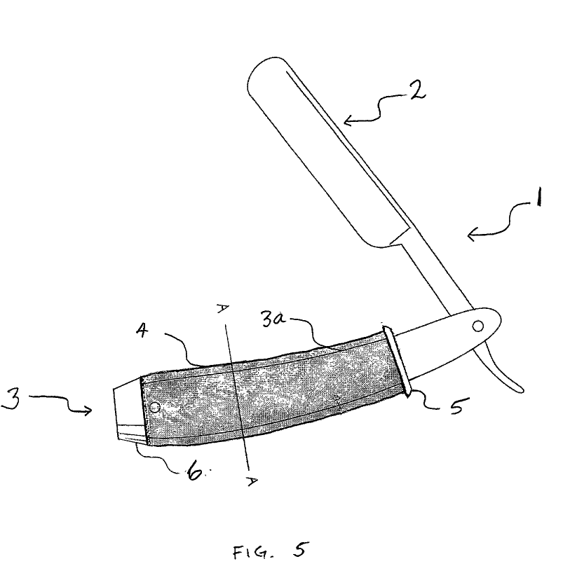

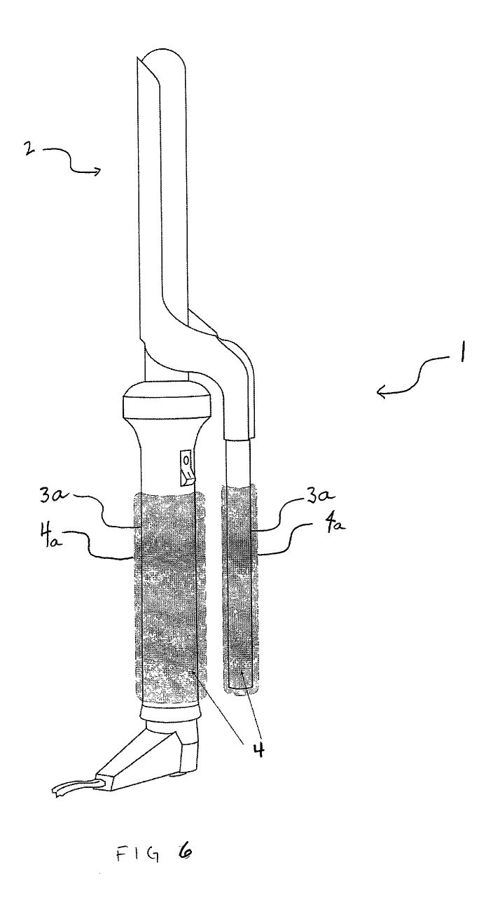

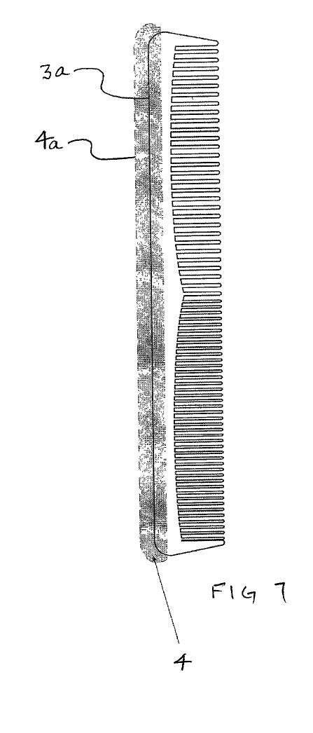

Turning to the drawings, one possible arrangement of the components of the grip 4 is shown in FIG. 1. The outer portion of the grip is formed by a thin resilient outer surface 4a, encasing a viscous material 4b, directly surrounding at least a portion of the stem 3a. FIG. 2 shows a cross-section of this embodiment, wherein the outer layer is a sleeve that surrounds the viscous material and the stem, the stem having a central cavity 3b.

FIG. 3 illustrates an embodiment in which the grip 4 comprises an outer surface 4a separated from an inner surface 4c by the viscous material 4b, the inner surface directly surrounding at least a portion of the stem 3a.

FIG. 4 shows an alternative arrangement of the grip 4 of FIG. 3, in which the inner surface 4c and the outer surface 4a, are part of a single extrusion, and are connected by radially directed webs 4d, which define individual chambers 4e in which the viscous material 4b resides. Each web is equipped with vents 4f, permitting movement of the viscous material from one chamber to another, in response to pressure on the outer layer.

The grip 4 of the present invention is capable of receiving into itself the stem 3a of the handle 3 of the salon tool 1. The grip may do this by being in the form of a sleeve that surrounds the stem. Alternatively, the grip may receive the stem into itself by having a portion of the grip that is folded in on itself. Either way, the grip receives into itself at least a portion of the stem of the handle of the tool.

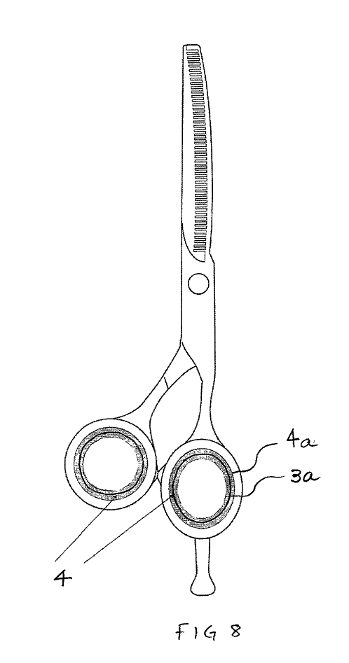

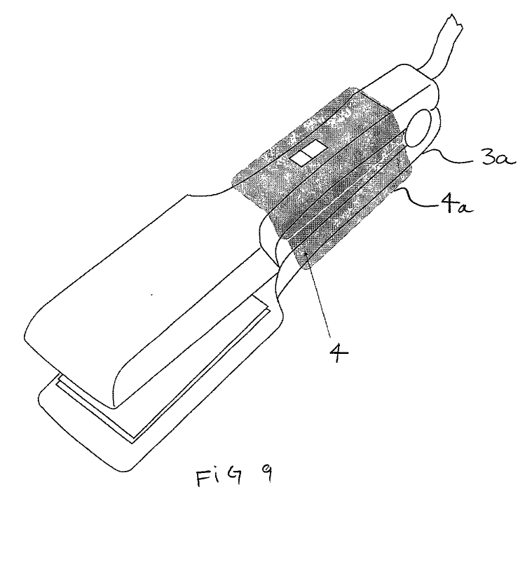

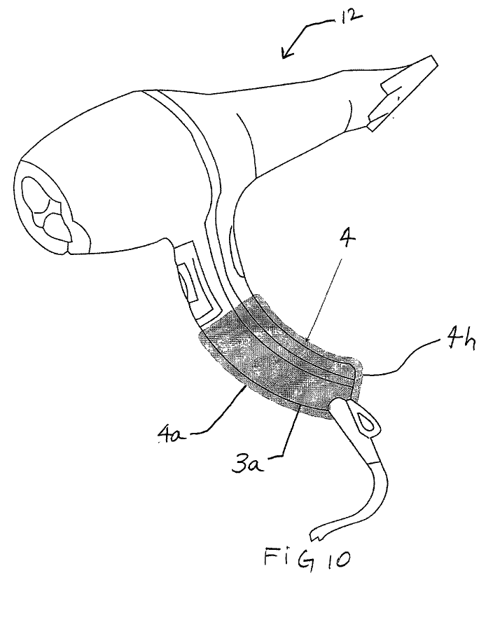

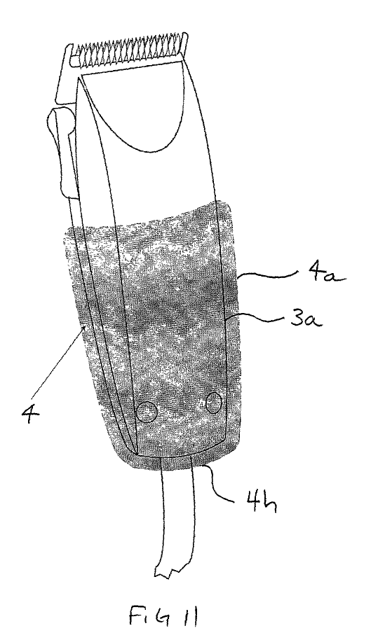

An exemplary tool of the first type is shown in FIG. 5 where a razor 1 is depicted. As shown therein, the razor generally comprises a head region 2, and a generally cylindrical handle region 3 that projects away from the head region. The handle region comprises an inner stem 3a, which is radially surrounded by an outer deformable sleeve grip 4. At the point at which the upper end of the grip contacts the stem, an optional cuff 5 is added and an optional cap 6 is added to finish off the bottom of the stem. Alternatively, the grip may be generally cylindrical but have a closed end 4h in stead of a cap, as shown in FIGS. 10 and 11. FIG. 6 illustrates a curling iron 1 with two generally cylindrical handle stems 3a, each radially surrounded by a deformable sleeve grip 4. In the salon tools of FIGS. 5, 6, 10 and 11, the stem projects out and away from the head 2 of the tool. In this case the grip is in the form of a sleeve that surrounds the perimeter of the stem, as shown in FIGS. 1-4. Some salon tools, however, have a stem that does not project away from the head and whose perimeter cannot be conveniently surrounded by a sleeve grip. FIGS. 7 and 8 show two such tools.

FIG. 7 illustrates a comb fitted with a grip 4 of the present invention. In this case the grip comprises the same layers of any of the embodiments described in FIGS. 1-4. The difference here is that the back edge (i.e. stem 3a) of the comb is not completely surrounded. Rather, the grip is adapted to receive a portion of the back edge of the comb. (As used throughout, the stem is that portion of the tool which the hand or fingers would normally contact if the grip of the invention was not present.) In this case, a groove 4g extending along the length of the grip is capable of receiving into itself a portion of the back edge of the comb. The groove is formed by folding the grip in on itself (see FIG. 13). Preferably, the grip is retained on the comb by friction, but adhesive may be used.

In FIG. 8 a pair of shears is shown with the grip 4 of the present invention fitted onto the inner diameters of the finger loops (i.e the stem 3a of the handle region). A groove extending around the outer diameter of the grip loop is capable of receiving into itself the inner diameter of the finger loop. Preferably, the grip is retained on the shears by friction, but adhesive may be used. Shears of this type provide a significant advantage over ordinary shears the use of which often results in blisters, calluses, cramping muscles of the hand, etc., all leading to inferior performance by the user.

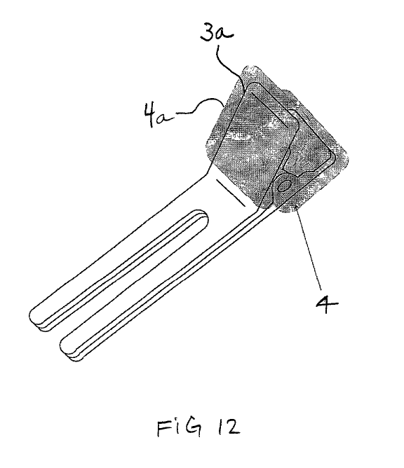

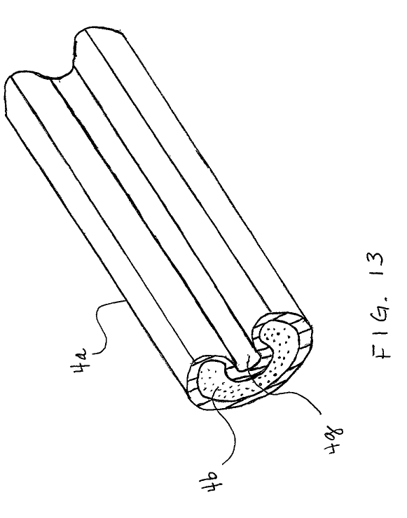

Additional salon and spa tools of the present invention are shown in FIGS. 9-12. In each case the shape of the grip conforms to the handle stem 3a. When it comes to stems that project away from the head of the tool, the grip may be either of the sleeve-type or of the folded-in type. The folded-in type is preferred when only a portion of the stem is to be provided with a grip, rather than surrounding the whole stem. The invention is not limited to the specific details shown and described. Various modifications will be suggested to one skilled in the art, all of which are within the scope of this invention.

What is claimed is:

1. A salon tool comprising:
a head region that contains one or more elements adapted to be directed toward the hair or body;
a handle region having a stem; and
a deformable grip adapted to receive at least a portion of the stem into itself.

2. The tool of claim 1 in which the grip comprises a deformable outer surface.

3. The tool of claim 2 in which the deformable outer surface surrounds an inner layer of a deformable viscous medium, the viscous medium being between the outer surface and the stem.

4. The tool of claim 3 in which an inner surface is positioned between the stem and the viscous medium.

5. The tool of claim 3 in which the viscous medium is a putty.

6. The tool of claim 5 in which the viscous medium is a vinyl elastomer or silicone-based putty.

7. The tool of claim 3 in which the viscous medium is a room-temperature curable substance.

8. The tool of claim 1 in which the deformable grip comprises an inner surface and an outer surface, the inner and outer surfaces being connected by radially oriented webs defining chambers containing the viscous medium within the grip, each web containing at least one vent dimensioned so as to permit the passage of the viscous medium from one chamber to another when pressure is placed on the grip.

9. The tool of claim 8 in which the viscous material is a flowable substance.

10. The tool of claim 9 in which the viscous material is a silicone lubricant.

11. The tool of claim 1 wherein the grip is in the form of a sleeve that radially surrounds the stem of the handle.

12. The tool of claim 1 wherein the grip comprises a groove that receives at least a portion of the stem into itself, the groove being formed by folding the grip in on itself.

13. A salon tool according to claim 1 selected from the group consisting of hair cutting tools, combs, hair clips, sectioning tools, blow dryers, flat irons, crimping irons, curling irons, hot irons, thermal styling tools, nail files, nail clippers, nail buffers, nail nippers, nail pushers, make-up applicators and handheld massagers.

14. Shears comprising:
a head region that contains one or more elements adapted to be directed toward the hair;
a handle region comprising finger loops, each finger loop having an inner diameter; and
deformable grips located on each inner diameter.

15. The shears of claim 14 in which each grip comprises a deformable outer surface.

16. The shears of claim 15 in which the deformable outer surface surrounds an inner layer of a deformable viscous medium, the viscous medium being between the outer surface and the inner diameter of the finger loops.

17. The shears of claim 16 in which an inner surface is positioned between the inner diameter and the viscous medium.

18. The shears of claim 16 in which the viscous medium is a putty.

19. The shears of claim 18 in which the viscous medium is a vinyl elastomer or silicone-based putty.

20. The shears of claim 16 in which the viscous medium is a room-temperature curable substance.

21. The shears of claim 14 in which each deformable grip comprises an inner surface and an outer surface, the inner and outer surfaces being connected by radially oriented webs defining chambers containing the viscous medium within each grip, each web containing at least one vent dimensioned so as to permit the passage of the viscous medium from one chamber to another when pressure is placed on the grip.

22. The shears of claim 21 in which the viscous medium is a flowable substance.

23. The shears of claim 22 in which the viscous medium is a silicone lubricant.

23. The shears of claim 13 wherein each grip comprises a groove that receives at least a portion of the inner diameter into itself, groove being formed by folding the grip in on itself.
